(19) United States
(12) Patent Application Publication
(10) Pub. No.: US 2011/0018440 A1
(43) Pub. Date: Jan. 27, 2011

(54) LIGHTING UNIT, LIGHTING METHOD, AND EXTERNAL STORAGE DEVICE EQUIPPED WITH LIGHTING UNIT

(75) Inventor: Takuhei FUKUDA, Nagoya-shi (JP)

Correspondence Address: Beyer Law Group LLP, P.O. BOX 1687, Cupertino, CA, 95015-1687, US

(73) Assignee: BUFFALO INC.

(21) Appl. No.: 12/839,935

(22) Filed: Jul. 20, 2010

(30) Foreign Application Priority Data
Jul. 21, 2009 (JP) 2009-169725

(51) Int. Cl. B60Q 1/14; F21V 3/00; F21V 7/00

(52) U.S. Cl. 315/77; 362/311.01; 362/296.01

(57) ABSTRACT

A lighting unit is provided which comprises a casing; a light source disposed inside the casing; a light-diffusing member for diffusing at least part of light emitted by the light source; a light-blocking member for blocking part of the light emitted by the light source; and a light-transmitting portion for transmitting toward the outside of the casing at least part of the light which has been diffused by the light-diffusing member, wherein the light-blocking member is laid out straightly over the light source, the direction from the light source straightly upward being the direction of highest intensity of the light emitted by the light source.

### CROSS-REFERENCE TO RELATED APPLICATIONS

The present application claims relates the priority based on Japanese Patent Application No. 2009-169725, filed on Jul. 21, 2009, the disclosure of which is incorporated by reference in its entirety.

### BACKGROUND OF THE INVENTION

1. Field of the Invention

The present invention relates to a lighting unit, to a lighting method, and to an external storage device equipped with lighting unit.

2. Description of the Related Art

Techniques for spreading light emitted by an LED (Light Emitting Diode) over a wider angular range by diffusing the light from the light source by a light-diffusing member are known in the prior art (see, for example, JP2006-100124A)

### SUMMARY

However, in case where the distance between the LED and the light-diffusing member is relatively short, intensity irregularity may occur in the light that has been diffused by the light-diffusing member and exited toward outside, depending on the positional relationship between the LED and the light-diffusing member. This problem is not limited to lighting units that employ LED light sources, but is common to lighting units that cast light emitted by a light source having directional characteristics.

Accordingly, an object of this invention is to reduce the luminance irregularities of the lighting units that employ a directional light source.

The present invention has been made to attain the above objects at least in part according to the following embodiments of the invention.

### First Example of Application

According to a first example of application of the present invention, there is provided a lighting unit comprising:
a casing;
a light source disposed inside the casing;
a light-diffusing member for diffusing at least part of light emitted by the light source;
a light-blocking member for blocking part of the light emitted by the light source; and
a light-transmitting portion for transmitting toward the outside of the casing at least part of the light which has been diffused by the light-diffusing member,
wherein the light-blocking member is laid out straightly over the light source, the direction from the light source straightly upward being the direction of highest intensity of the light emitted by the light source.

According to the lighting unit of the first example of application, at least part of the light emitted by the light source is diffused by the light-diffusing member, which gives it uniform intensity. Light beams of uniform intensity then exit to the outside via the light-transmitting portion. Meanwhile, the light beams of highest intensity, which are emitted in the direction from the light source straightly upward, is prevented from traveling (being propagated) further in the direction from the light source straightly upward by the light-blocking member. It, therefore is possible to reduce intensity irregularity of light beams exiting to the outside via the light-transmitting portion, which may arise depending on the positional relationship between the light source and the light-diffusing member. Hereinafter, “the direction from the light source straightly upward” shall be termed also “the straight upward direction”.

### Second Example of Application

According to a second example of application of the present invention, there is provided the lighting unit according to the first example of application described above, wherein
the light-diffusing member is positioned between the light source and the light-blocking member.

According to the lighting unit of the second example of application, a larger part of the light emitted by the light source can enter the light-diffusing member so that the light is diffused in the planar direction of the light-diffusing member. The light emitted by the light source can thus be utilized efficiently to exit toward the outside of the unit.

### Third Example of Application

According to a third example of application of the present invention, there is provided the lighting unit according to the first example of application described above, wherein
the light-diffusing member has a first face and a second face, both intersecting the direction from the light source straightly upward, and
at least one of the first and second faces has a rugged or rough surface to alter a direction of light propagation.

According to the lighting unit of the third example of application, by altering the direction of propagation of light using the rugged or rough surface of the light-diffusing member, the light can be better diffused in the planar direction of the light-diffusing member. Thus, the intensity of the light can be made more uniform, and the uniform light exits to the outside via the light-transmitting portion. It, therefore, is possible to further reduce intensity irregularity of light beams exiting to the outside via the light-transmitting portion.

### Fourth Example of Application

According to a fourth example of application of the present invention, there is provided the lighting unit according to the first example of application described above, wherein
the light-blocking member has a function of reflecting the light emitted by the light source back into the inside of the casing, and
the light-diffusing member diffuses at least part of the reflected light.

According to the lighting unit of the fourth example of application, the light that is reflected back by the light-blocking member is also diffused in the planar direction by the light-diffusing member, so that the light emitted by the light source can be utilized even more efficiently and exit toward the outside of the unit.

### Fifth Example of Application

According to a fifth example of application of the present invention, there is provided the lighting unit according to the fourth example of application described above, wherein
the light-blocking member has a first face and a second face, both intersecting the direction from the light source straightly upward;
wherein the first face fronts the light source and the second face is opposite to the first face;
wherein the first face has a function of reflecting the light emitted by the light source, and the second face has a function of absorbing the light passing through the first face.

According to the lighting unit of the fifth example of application, since the second face has the function of absorbing light, at least those light beams emitted from the light source and traveling in the straight upward direction can be prevented from exiting to the outside. Therefore, the intensity irregularity of the light beams exiting to the outside can be reduced.

### Sixth Example of Application

According to a sixth example of application of the present invention, there is provided the lighting unit according to the first example of application described above, wherein

the light-transmitting portion is separated from the light-diffusing member, and is colored in a color similar to an emission color of the light source.

According to the lighting unit of the sixth example of application, the light of a color similar to the emission color of the light source can be radiated to the outside through the light-transmitting portion. Here, the color similar to the emission color of the light source refers not only to the same hue as that of the emission color of the light source, but also to colors of hues similar to the hue of the emission color of the light source. Colors of the same hue herein refer to any pair of colors whose hue difference is zero, as shown in FIG. 4, in the 20-color hue circle (also called the modified Munsell hue circle) used in JIS standards (JIS Z 8102). And colors of similar hues refer to any pair of colors whose hue difference is from 1 to 3 in the 20-color hue circle.

### Seventh Example of Application

According to a seventh example of application of the present invention, there is provided the lighting unit according to the first example of application described above, wherein
the light-transmitting portion is separated from the light-diffusing member, and has a function of diffusing the light that has passed through the light-diffusing member and has entered the light-transmitting portion.

According to the lighting unit of the seventh example of application, because light is further diffused in the planar direction of the light-transmitting portion also in the light-transmitting portion, the intensity irregularity of the light beams exiting to the outside can be reduced further.

### Eighth Example of Application

According to an eighth example of application of the present invention, there is provided the lighting unit according to the sixth example of application described above, wherein
the light-transmitting portion has a first face and a second face, both intersecting the direction from the light source straightly upward, and
at least one of the first and second faces has a rugged or rough surface to alter the direction of light propagation.

According to the lighting unit of the eighth example of application, by altering the direction of propagation of light using the rugged or rough surface of the light-transmitting portion, the light can be better diffused in the planar direction of the light-transmitting portion. Thus, the intensity of the light can be made more uniform by the light-transmitting portion, and the intensity irregularity of the light beams exiting to the outside can be reduced further.

### Ninth Example of Application

According to a ninth example of application of the present invention, there is provided the lighting unit according to the first example of application described above, wherein
the light source is positioned at a location that is not directly visible from the outside of the lighting unit through the light-transmitting portion.

According to the lighting unit of the ninth example of application, the emission of the light source cannot be seen directly from outside the lighting unit through the light-transmitting portion. Accordingly, the light of uniform intensity having been diffused by the light-diffusing member exits to the outside via the light-transmitting portion. Thus, viewed from outside the unit, the entire the light-transmitting portion appears to uniformly emit light, thereby affording lighting unit having an excellent display quality.

### Tenth Example of Application

According to a tenth example of application of the present invention, there is provided an external storage device comprising:
a storage portion for storing data;
the lighting unit according to the first example of application; and
a controller for controlling operating state of the light source of the lighting unit according to operating state of the external storage device.

According to the external storage device of the tenth example of application, an external storage device can be provided which has a light-transmitting portion with reduced brightness irregularity and excellent display quality. Additionally, the light-transmitting portion in display quality can notify the user of the operating state of the external storage device.

### Eleventh Example of Application

According to an eleventh example of application of the present invention, there is provided the external storage device according to the tenth example of application described above, wherein
the operating state of the light source includes at least a first operating state and a second operating state different from the first operating state, and wherein
when the electronic device connected to the external storage device accesses the storage portion, the controller switches the light source from its first operating state to its second operating state.

According to the external storage device of the eleventh example of application, the light-transmitting portion having an excellent display quality can notify the user of the access to the external storage device by an electronic device.

### Twelfth Example of Application

According to a twelfth example of application of the present invention, there is provided the external storage device according to the tenth example of application described above, wherein
at least when the external storage device is powered ON, the controller causes the light source to emit light.

According to the external storage device of the twelfth example of application, the light emission out of the light-transmitting portion excellent in display quality can notify the user that the external storage device is powered ON.

### Thirteenth Example of Application

According to a thirteenth example of application of the present invention, there is provided a lighting method of conducting to the outside of a casing light emitted by a light source disposed inside the casing, the method comprising the steps of:
(a) diffusing the light emitted by the light source;
(b) blocking at least that part of the light emitted by the light source which travels in the direction from the light source straightly upward, the direction from the light source straightly upward being the direction of highest intensity of the light emitted by the light source; and
(c) conducting at least part of the diffused light to outside the casing.

According to the lighting method of the thirteenth example of application, the intensity irregularity of light beams exiting to the outside can be reduced.

The present invention may be practiced as various embodiments that will be described below.

These and other objects, features, aspects, and advantages of the present invention will become more apparent from the following detailed description of the embodiments with the accompanying drawings.

### BRIEF DESCRIPTION OF THE DRAWINGS

FIG. 1 shows in block diagram the circuit configuration of an external storage device provided with a lighting unit according to a first embodiment of the present invention;

FIGS. 2(A) and 2(B) show the exterior features of an external storage device provided with a lighting unit according to the present invention;

FIG. 3 is a drawing illustrates the arrangement of the lighting unit and the panel member of the external storage device according to an embodiment of the present invention;

FIG. 4 is the 20-color hue circle;

FIGS. 5(A) and 5(B) show the internal structures of an external storage device;

FIG. 6 illustrates a preferred range of locations where the LED is to be placed; and

FIGS. 7(A) and 7(B) illustrate a lighting unit according to a second embodiment of the present invention, and an external storage device equipped with the lighting unit.

### DETAILED DESCRIPTION OF THE EMBODIMENT

The modes of practice of the present invention are described below in the following order:

### A. First Embodiment:

### B. Second Embodiment:

### C. Modified Embodiments:

### A. First Embodiment

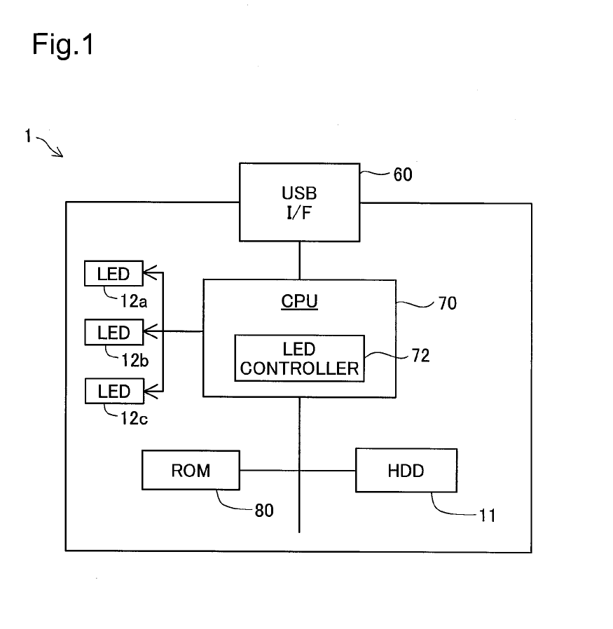

FIG. 1 shows in block diagram the circuit configuration of an external storage device provided with a lighting unit according to a first embodiment of the present invention. The external storage device 1 is designed to connect to an external electronic device, such as, for example, a personal computer or digital camera, and to exchange data with the electronic device. The external storage device 1 has a USB interface 60, a CPU 70, a ROM 80 for storing a prescribed program, an HDD 11 for storing data, and LEDs 12a, 12b, 12c. The USB interface 60 has a Universal Serial Bus (USB) in compliance with the serial bus standard, and is designed to connect to an electronic device via a connector cable. The CPU 70 controls writing and reading of data into and out of the HDD 11, and controls the operating state of the LEDs 12a to 12c according to the operating state of the external storage device 1. Specifically, when the external storage device 1 is connected to an electronic device via a connector cable and the external storage device 1 is powered ON, an LED controller 72 turns on the first to third LEDs 12a to 12c. Light emission of a display, discussed later, informs the user that the external storage device 1 is powered ON. The LED controller 72 also turns on and off the first to third LEDs 12a to 12c periodically when the electronic device is accessing the HDD 11 of the external storage device 1. This flashing of the display informs the user that the external storage device 1 is being accessed by the electronic device.

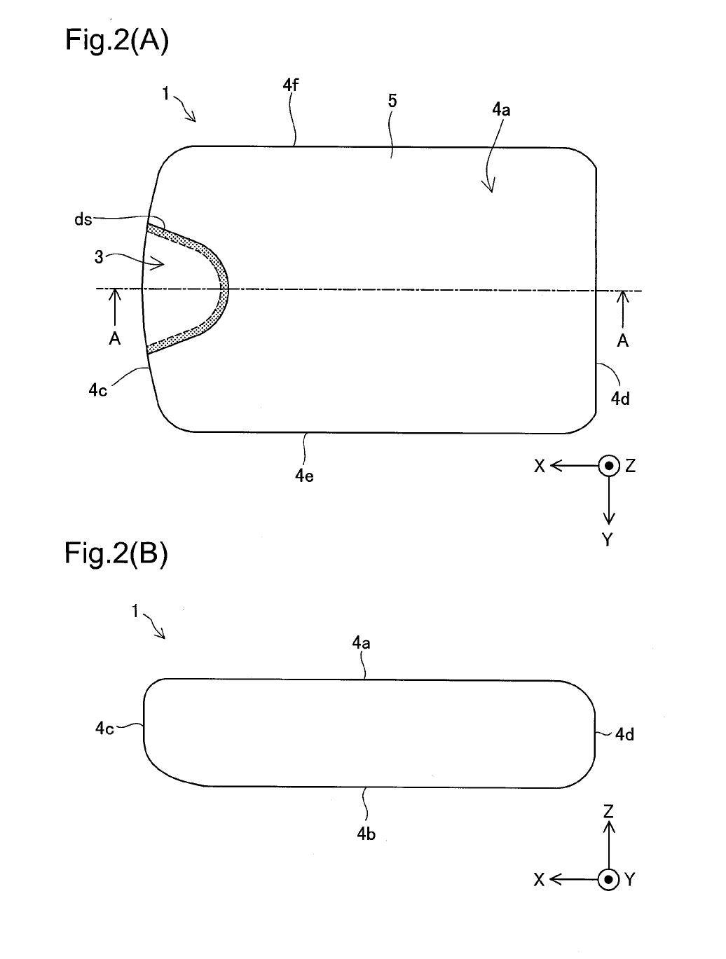

FIGS. 2(A) and 2(B) show the exterior features of an external storage device provided with a lighting unit according to the present invention. FIG. 2 (A) shows the external storage device in plan view, and FIG. 2 (B) shows the external storage device in side view. FIGS. 2(A) and 2(B) also show X, Y, and Z axes for indicating direction. The double circle on the X, Y, and Z axes indicates that the Z axis positive direction is pointing toward the viewer from the plane of the page.

The external storage device 1 is compact and lightweight enough to be portable. The external storage device 1 has a roughly parallelepiped shape including a face 4a on the Z axis positive direction side, a face 4b on the Z axis negative direction side, a face 4c on the X axis positive direction side, a face 4d on the X axis negative direction side, a face 4e on the Y axis positive direction side, and a face 4f on the Y axis negative direction side. The external storage device 1 is usually positioned with the face 4a as the top face and the face 4b as the bottom face, for use by the user. Herein, the face 4a shall be termed also the upper face, the face 4b shall be termed also the bottom face, the face 4c shall be termed also the front face, the face 4d shall be termed also the back face, the face 4e shall be termed also the right side face, and the face 4f shall be termed also the left side face.

The external storage device 1 has a cover member 5 and a panel member 3. The cover member 5 and the panel member 3 are separate components; the cover member 5 is designed to attach to the panel member 3 to define an enclosed space inside. A light source and an HDD (Hard Disk Drive), discussed later, are installed inside the external storage device 1. The cover member 5 is made of an impact-resistant material. ABS resin may be used as such a material for example. The cover member 5 is colored black so that it does not transmit light.

The panel member 3 constitutes part of the lighting unit according to an embodiment of the present invention. The panel member 3 is attached to the front face 4c side of the upper face 4a. Part of the light emitted by the light source housed inside the casing is transmitted through a part of the panel member 3 and exits to the outside of the external storage device 1. As a result, a band-shaped (U-shaped) section of the panel member 3 emits light (lights up). In FIG. 2 (A), the band-shaped illuminated section is indicated by shading with dots. Herein, this band-shaped illuminated zone is also called the “display ds”. The display ds lights up when the external storage device 1 is powered ON, and flashes when the electronic device is accessing the HDD 1 of the external storage device 1. That is, the display ds has the function of indicating the ON/OFF state of the external storage device 1, and the function of indicating the status of the external storage device 1 being accessed by the electronic device. Additionally, the external storage device 1 has a slot (not shown) on its back face 4d for inserting a connector. The external storage device 1 uses a bus-powered method, and is energized by the electronic device to which the external storage device 1 is connected via a connector.

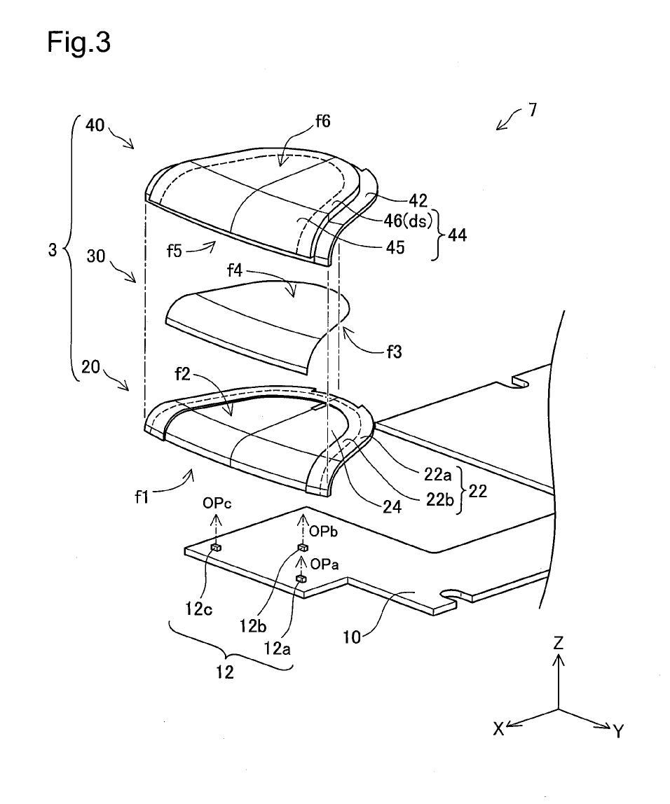

FIG. 3 illustrates the arrangement of the lighting unit and the panel member of the external storage device according to an embodiment of the present invention. FIG. 3 is an exploded perspective view of the external storage device 1; the drawing includes the panel member 3 and a light source 12. The external storage device 1 has a lighting unit 7 according to the first embodiment of the present invention. The lighting unit 7 has various components discussed below. The cover member 5 is omitted in the drawing. The light source of the lighting unit 7 employs point light sources. Specifically, LEDs (Light Emitting Diodes) 12 that emit blue light are used. Three LEDs 12 are provided, and the first to third LEDs 12a to 12c are arranged on a circuit board 10 of the external storage device 1. The LEDs 12a to 12c are arranged on a circuit board 10 in such a way that light beams emitted in parallel to the Z axis from LEDs 12a to 12c have the highest intensity. Here, when the direction of highest intensity is the straight upward directions OPa, OPb, OPc (the Z axis positive direction in the plane of the page), the LEDs 12a to 12c have an axially symmetric intensity distribution with the axis of symmetry lying in the straight upward direction OPa, OPb, OPc. That is, the LEDs 12a to 12c exhibit decreasing intensity as the solid angle increases with respect to each of the center axes. In this instance, the light-transmitting portion, discussed later, is not positioned in the straight upward direction OPa, OPb, OPc of the LEDs 12a to 12c; rather, a light-blocking member is positioned there.

The panel member 3 has a light-diffusing member 20 to diffuse light, a light-blocking member 30 to block light, and a light-transmitting member 40 to transmit light. The members 20, 30, 40, stacked in that order, are attached to the cover member 5 (FIG. 2). Here, the cover member 5, the members 20, 30, 40, and the LEDs 12 are the main components that make up the lighting unit 7. The cover member 5 corresponds to the “casing” recited in the SUMMARY; and the cover member 5, the members 20, 30, 40, and the LEDs 12 together corresponds to the “lighting unit” recited in the SUMMARY.

The light-diffusing member 20 is a plate-shaped member of opaque white color having a curving section along one edge. The light-diffusing member 20 has the function of diffusing light in the planar direction of the light-diffusing member 20. Here, the planar direction of the light-diffusing member 20 means the direction that, of the two faces f1, f2 of the light-diffusing member 20, lies along (is parallel to) the face f2 on the opposite side of the face f1 that fronts the LEDs 12. The light-diffusing member 20 is made of resin, such as, for example, polycarbonate containing a light-diffusing agent. The light-diffusing member 20 has a recessed portion 24 and a periphery portion 22 defined by part of the periphery section of the recessed portion 24. The recessed portion 24 is a section of the face f2 that is recessed below the periphery portion 22. The periphery portion 22 is in turn composed of a first section 22a which is the section situated further away from the recessed portion 24 (more toward the outside), and a second section 22a which is the section situated closer (to the recessed portion 24 more toward the inside). The first section 22a is adapted to fit together with the cover member 5 to secure the light-diffusing member 20 to the cover member 5. The second section 22b is a section adapted to transmit light emitted by the LEDs 12 toward the light-transmitting member 40. Of the two faces f1, f2 of the light-diffusing member 20, the face f1 that fronts the LEDs 12 is made rugged or corrugated to change the direction of propagation of light. That is, the face f1 has undergone a surface roughing process.

The light-blocking member 30 is a member of seal form having the function of blocking part of the light emitted by the LEDs 12. Specifically, it has the function of preventing the light incident onto the face f3 facing the LEDs 12) from exiting through the face f4 that is situated on the opposite side. The light-blocking member 30 has the additional function of reflecting light impinging on the face f3 back toward the inside of the casing. The light-blocking member 30 may be a sheet of metal such as aluminum or silver, or a component having a layer of metal such as aluminum, silver, or gold deposited on at least one of the faces of a resin sheet (in the present embodiment, at least on the face f3). In the present embodiment, the light-blocking member 30 is a seal that includes aluminum as a component, and the face f4 of the seal is painted black. By painting the face f4 black, light entering the light-blocking member 30 at the face f3 is absorbed in the face f4, so that the light blocking ability of the light-blocking member 30 can be improved, as compared to the case where it is not painted black. The light-blocking member 30 is adhered in place to cover the entire recessed portion 24 of the light-diffusing member 20.

The light-transmitting member 40 is a plate-shaped member generally identical in shape to the light-diffusing member 20 so that when attached to the cover member 5 as part of the panel member 3, an excessive gap does not form between the light-diffusing member 20 and the light-transmitting member 40. The light-transmitting member 40 has the function of transmitting light. The light-transmitting member 40 is made of resin such as, for example, polycarbonate or polyethylene terephthalate. The light-transmitting member 40 has a thick portion 44 of greater thickness, and a thin portion 42 of smaller thickness than the thick portion 44. In the thick portion 44, light exits toward the outside through a light-transmitting section 46 that is not overlapped by the light-blocking member 30. That is, the light-transmitting section 46 serves as the display ds. For better understanding, in the light-transmitting member 40, the display ds and a section 45 that is not display ds (herein termed also “inner section 45”) are delineated with a broken line at their boundary. The thin portion 42 is the section that attaches to the cover member 5. Here, the light-transmitting section 46 corresponds to the “light-transmitting portion” recited in the SUMMARY.

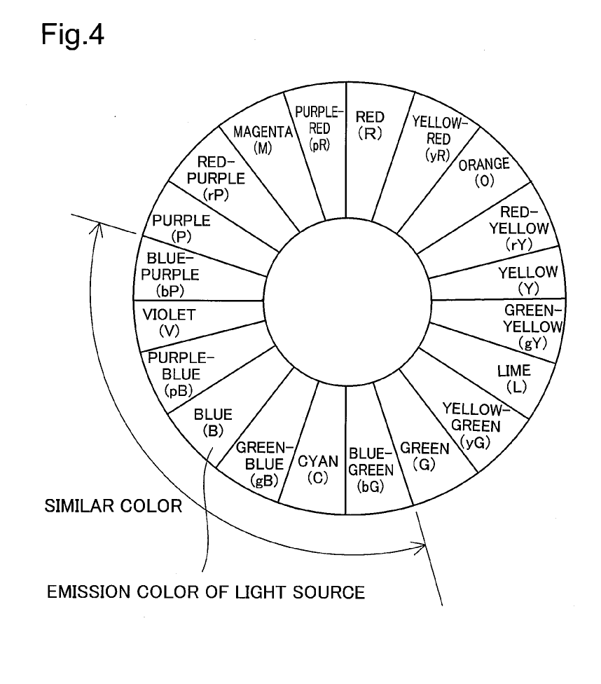

At least the light-transmitting section 46 in the light-transmitting member 40 is preferably colored in color similar to the emission color of the LEDs 12 (blue). Here, a color being similar to the emission color of the LEDs 12 (in this case the emission color is blue) does not mean that the color in question has the same hue as the emission color of the light source, but means that it may have one of hues similar to the hue of the emission color of the LED 12. Colors of the same hue herein refer to any pair of colors whose hue difference is zero, as shown in FIG. 4, in the 20-color hue circle (also called the modified Munsell hue circle) used in JIS standards (JIS Z 8102). And colors of similar hues refer to any pair of colors whose hue difference is from 1 to 3 in the 20-color hue circle. FIG. 4 is the circular diagram of the 20-color hue circle. For example, if the emission color of the light source is blue (B) and the light-transmitting section 46 is colored in the same blue (B), the hue difference is zero. If the emission color of the light source is blue (B) and the light-transmitting section 46 is colored in blue-purple (bP) or blue-green (bG), the hue difference is 3. That is, when the emission color of the light source is blue (B), if the light-transmitting section 46 is colored in one of hues ranging from blue-purple (bP) to blue-green (bG), the emission color of the light source and the color of the light-transmitting section 46 are considered to be similar to each other. Thus, the light of color similar to the emission color of the LEDs 12 (blue) can be emitted toward outside.

Also, at least the light-transmitting section 46 in the transmission member 40 preferably has an overall transmittance of 5% to 50% with respect to all light wavelengths. Where the overall transmittance is kept to 50% and less, the light intensity transmitted through the light-transmitting section 46 can be more uniformed, and the intensity irregularity of light beams exiting out of the light-transmitting section 46 can be further reduced. If the overall transmittance is less than 5%, the light-transmitting section 46 has excessively low brightness, posing a risk that its function as the display ds may be impaired.

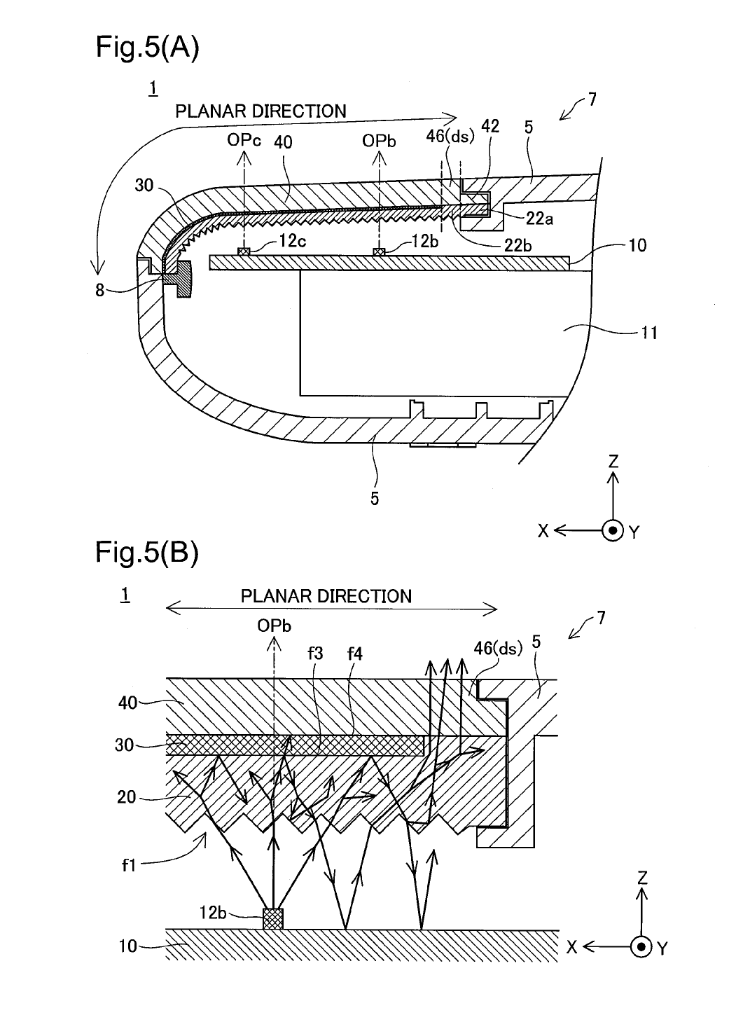

FIGS. 5(A) and 5(B) show the internal configuration of an external storage device. FIG. 5 (A) is a cross sectional view taken along line A-A in FIG. 2 (A). FIG. 2 (B) is an enlarged detail of the area around the second LED 12b in FIG. 5 (A), with travel (propagation) paths of light emitted by the second LED 12b indicated with arrows.

As shown in FIG. 5 (A), the circuit board 10, the HDD 11, and a middle case 8 are installed inside the external storage device 1. The middle case 8 is a component designed to mitigate the direct external shocks to the HDD 11, and is mounted onto the inside wall of the cover member 5 so as to enclose the perimeter of the HDD 11. This middle case may be made of resin such as, for example, ABS resin.

As shown in FIG. 5 (B), light emitted by the second LED 12b is diffused in the planar direction of the light-diffusing member 20 by the light-diffusing member 20 so that the intensity of the incident light onto the light-transmitting section 46 is uniformed. Additionally, the rugged surface of the face f1 changes the direction of light propagation (in other words, the light beams are scattered in plural directions by the rugged surface) so that the light is further diffused in the planar direction of the light-diffusing member 20. As a result, the intensity of the incident light onto the light-transmitting section 46 is more uniformed. Meanwhile, the light beams of the highest intensity emitted in the straight upward direction OPb of the second LED 12b, as well as the light beams of relatively high intensity emitted within a certain solid angle with respect to the straight upward direction OPb, are blocked by the light-blocking member 30, and cannot travel toward the straight upward direction OPb and directly exit from the external storage device 1. Thus, of the light beams diffused by the light-diffusing member 20, the light beams of relatively low intensity and minimal difference in intensity exit out of the external storage device 1 via the light-transmitting section 46. Thus, despite the relatively short distance between the LEDs 12 and the light-diffusing member 20, the intensity irregularity of light beams exiting to the outside via the light-transmitting section 46 can be reduced. Also, because the intensity irregularity of the display ds can be reduced despite the relatively short distance between the panel member 13 and the LEDs 12, the external storage device 1 can be more compact. By providing the external storage device 1 with the lighting unit 7, the panel member 3 having an excellent display quality with less intensity irregularity can inform the user of the power ON/OFF state of the external storage device 1 and of the status of an electronic device accessing the HDD 11. Further, because the light-diffusing member 20 diffuses light in the planar direction of the light diffusing member 20, a smaller number of the LEDs 12, which are point light sources, may be provided, and the band-shaped (planar) display ds can be illuminated (lit) more uniformly.

The light-blocking member 30 has the function of reflecting light back to the inside of the external storage device 1, and further diffuses part of the reflected light in the planar direction in the light-diffusing member 20. The light emitted by the LEDs 12 can thus be utilized efficiently and let out through the light-transmitting section 46.

As shown in FIG. 5 (B), of the light beams reflected back to the inside of the external storage device 1, those light beams transmitted through the face f1 of the light-diffusing member 20 and traveling toward the circuit board 10 are reflected by the circuit board 10 and again enters the light-diffusing member 20. In this way, by positioning the circuit board 10 that reflects light farther than the LEDs 12 with respect to the light-blocking member 30, light emitted by the LEDs 12 can be utilized efficiently and let out through the light-transmitting section 46.

Further, because the face f4 of the light-blocking member 30 is painted black, light traveling inside the light-blocking member 30 is absorbed by the face f4. Thus, light is prevented from being transmitted to the outside from the inner section 45 (FIG. 3), making it possible to exclusively illuminate a face of given shape (in the first embodiment, a band shape).

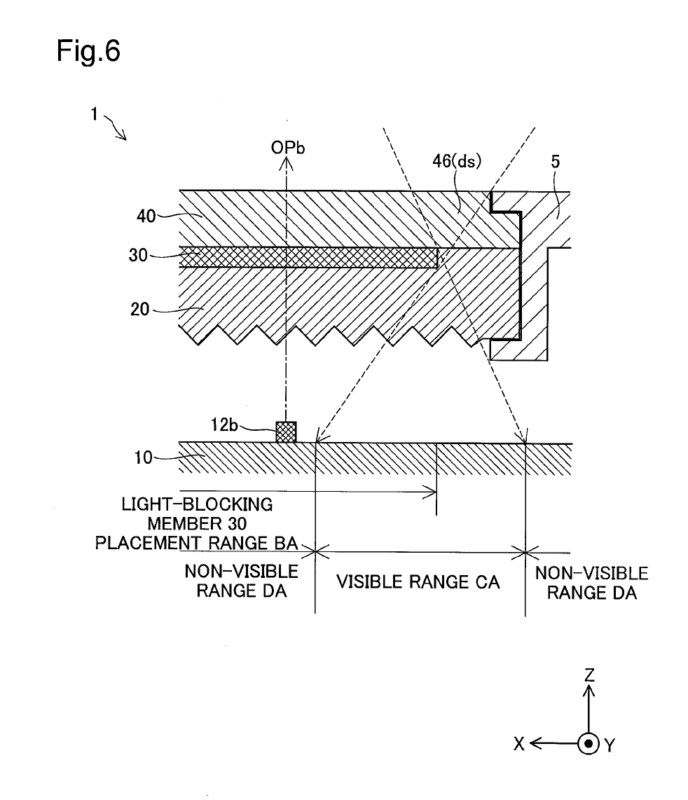

FIG. 6 illustrates a preferred arrangement of LEDs. Here, the LED 12b is used by way of example for the purposes of discussion, but the range of positioning of the other LEDs 12a, 12b is similar to that for the LED 12b. The second LED 12b is preferably positioned in the range DA within the range BA. The range BA is a range in which the light-blocking member 30 is situated perpendicular to the straight upward direction OPb. The range DA is a range in which the LED is not visible directly from the outside of the external storage device 1 through the light-transmitting section 46. That is, the component that blocks light transmission (in the present embodiment, the light-blocking member 30) is preferably so situated as to block the line-of-sight connecting the second LED 12b and the light-transmitting section 46. By so doing, the emission of the LEDs 12 is not visible directly from outside the external storage device 1, and the entire light-transmitting section 46 appears to uniformly emit light, whereby the external storage device 1 equipped with the panel member 3 having a more excellent display quality can be offered.

### B. Second Embodiment

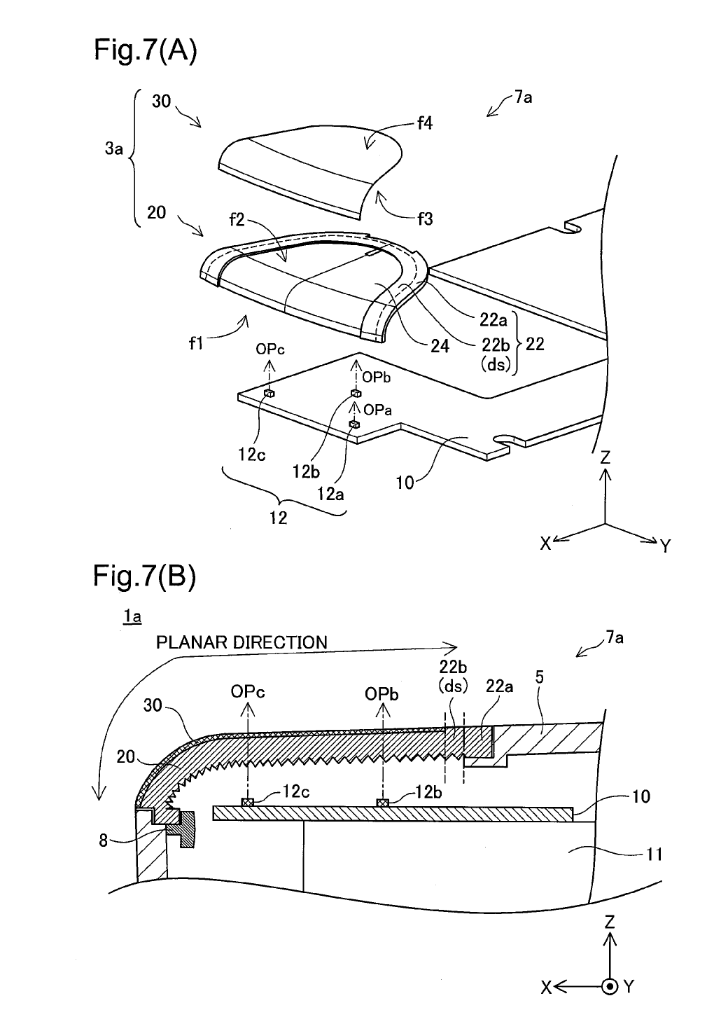

FIGS. 7(A) and 7(B) illustrate a lighting unit according to a second embodiment of the present invention, and an external storage device equipped with the lighting unit. FIG. 7 (A) is an exploded perspective view of the external storage device, and includes a panel member 3a and LEDs 12. As with the first embodiment, the cover member 5 (FIG. 2) is omitted from the illustration. FIG. 7 (B) is a partial cross sectional view corresponding to the A-A cross section in FIG. 2 (A). The lighting unit 7a of the second embodiment differs from the lighting unit 7 of the first embodiment (FIG. 3) in that no transmission member 40 is provided. Specifically, the lighting unit 7a of the second embodiment includes a cover member 5 (FIG. 2), a light-diffusing member 20, a light-blocking member 30, and LEDs 12. The external storage device 1a of the second embodiment differs from the external storage device 1 of the first embodiment in that it is furnished with the lighting unit 7a according to the second embodiment. The other hardware and software components are the same as those of the first embodiments. Therefore, like components are designated by like reference symbols and the description thereof is omitted to avoid repetition.

As shown in FIGS. 7 (A) and (B), the light-blocking member 30 is adhered to the recessed portion 24 of the light-diffusing member 20. In the second embodiment, light passed through the second section 22b of the light-diffusing member 20 and exits toward the outside. That is, the second section 22b constitutes the light-transmitting section 22b that serves as the display ds. In the second embodiment, the second section 22b corresponds to the “light-transmitting portion” recited in the SUMMARY. With this arrangement, too, the light emitted by the LEDs 12 is diffused in the planar direction of the light-diffusing member 20 by the light-diffusing member 20, and the intensity of the light is uniformed. Meanwhile, the light beams of highest intensity emitted in the straight upward directions indicated by arrows OPa, OPb, OPc, and the light beams of relatively high intensity emitted within a certain solid angle with respect to the straight upward directions OPa, OPb, OPc, are blocked by the light-blocking member 30, and cannot travel in the straight upward directions OPa, OPb, OPc and directly exit to the outside. Thus, as in the first embodiment, despite the relatively short distance between the LEDs 12 and the light-diffusing member 20, the intensity irregularity of the light beams exiting to the outside via the second section 22b can be reduced. Also, because the light-transmitting member 40 can be spared, fewer parts are needed in comparison with the first embodiment.

### C. Modified Examples

Of the constituent elements set forth in the embodiments hereinabove, elements other than those expressly recited in independent claims are supplemental elements and may be dispensed with as appropriate. The invention is not limited to the particular embodiments set forth hereinabove, but may be put into practice in various other such as in, for example, the following modifications while residing within the scope and spirit thereof.

### C1. Modified Example 1

In the preceding embodiments, the face f1 (FIG. 3) of the light-diffusing member 20 is a rugged or rough surface, but may instead be a smooth surface. Alternatively, the face f2 (FIG. 3) of the light-diffusing member 20 may be rugged or rough, or both of the faces f1, f2 may be rugged or rough. Such surface geometry may reduce intensity irregularity to a greater extent than where no light-blocking member is situated over the LEDs 12.

### C2. Modified Example 2

In the preceding embodiments, the light-blocking member 30 has the function of reflecting light, but if it has the function of blocking light, it need not necessarily have the function of reflecting light. As such a light-blocking member it may be possible to employ, for example, a member of seal form painted black on the face f3 (FIG. 3) thereof that fronts the LEDs 12. Such member can also reduce intensity irregularity to a greater extent than where no light-blocking member is situated over the LEDs 12. However, it is preferable for the light-blocking member 30 to have the function of reflecting light. The reason is that where the light-blocking member 30 has the function of reflecting light, the light beams emitted by the LEDs 12 can be utilized efficiently and exit to the outside from the light-transmitting section 46.

### C3. Modified Example 3

In the first embodiment described above, though the light-transmitting member 40 (FIG. 3) has only the function of transmitting light, it is still more preferable for at least the light-transmitting section 46 to have the additional function of diffusing light. In such a case, the light-transmitting member 40 may be made of resin such as, for example, polycarbonate or polyethylene terephthalate containing a light-diffusing agent. By doing so, the light-transmitting section 46 can make the intensity of light more uniform. The intensity irregularity of the light exiting to the outside from the light-transmitting section 46 can be further reduced thereby. As an alternative to adding a light-diffusing agent, at least one of the two faces f5, f6 of the light-transmitting section 46 may be provided with a rugged or rough surface for changing the direction of light propagation. The rugged or rough surface change the direction of light propagation and therefore diffuses light to a greater extent in the planar direction of the light-transmitting section 46. As a result, the intensity irregularity of light beams exiting to the outside from the light-transmitting section 46 can be further reduced. In this case, the face f5 (i.e. the face fronting the LEDs 12) preferably has a rugged or rough surface. The reason is that if the surface fronting the LEDs 12 is rugged or rough, the diffusion of light in the planar direction is better than if the surface not fronting the LEDs 12 is rugged or rough. It is still preferable that the transmission member 40 is made of material containing a light-diffusing agent, and has at least one rugged or rough surface. For this affords light diffusion in the planar direction of the light-transmitting section 46 to a greater extent.

### C4. Modified Example 4

In the preceding embodiments, the light-blocking member 30 is adhered to the face f2 situated opposite to the face f1 that fronts the LEDs 12 (FIGS. 3, 7), but the light-blocking member 30 may instead be adhered to the face f1 that fronts the LEDs 12. Such an arrangement can also reduce intensity irregularity to a greater extent than the light-blocking member 30 not being situated over the LEDs 12. In order to utilize the light beams emitted by the LEDs 12 more efficiently so that the light beams exits to the outside at the light-transmitting section (indicated at 46 in the first embodiment or at 22b in the second embodiment), it is preferable for the light-blocking member 30 having the function of reflecting light to be adhered to the face f1 that fronts the LEDs 12.

### C5. Modified Example 5

In the preceding embodiments, the LEDs 12 are employed as light sources, but no particular limitation is imposed on the type of light source to be used, and any light source having directional characteristics may be used. For example, organic EL (Electroluminescence) elements, inorganic EL elements, laser diodes, or other elements may be used as light sources. The color of the light emitted by the light source is not limited to blue, and monochromatic light such as red or green may be used instead. White light is also acceptable. Multiple light sources that emit lights of different colors respectively may be used. In such a case, it is preferable for the light-transmitting section (indicated at 46 in the first embodiment or at 22b in the second embodiment) to be colored in a color similar to the color of the light sources. In the case of multiple light sources that respectively emit lights of different colors, “the emission color of the light sources” refers to the color produced as a result of mixing the different color lights emitted by the multiple light sources. The number of light sources provided may be selected freely in consideration of the size and shape of the surface of the light-transmitting portion.

### C6. Modified Example 6

While the preceding embodiments described examples in which the lighting unit 7, 7a is employed as both a power indicator and an access indicator of the external storage device 1, 1a, the lighting unit 7, 7a may be employed as an indicator for providing the outward notification of various device states through lighting up or flashing. For example, the unit may be employed as an indicator for a network connection device such as a wireless LAN device. It is possible thereby to realize various devices equipped with indicators excellent in display quality by reducing intensity irregularity.

Also, while the preceding embodiments described examples in which the lighting unit 7, 7a is to an external storage device 1, 1a equipped with an HDD 11, the lighting unit 7, 7a may be implemented in an external storage device having some other type of storage such as a flash memory. Thus, there is realized an external storage device equipped with a lighting unit which can reduce the intensity irregularity of the light sources.

### C7. Modified Example 7

In the preceding embodiments, the light emitted by the LEDs 12 lights up or flashes through a display ds of band shape. However, the shape of the display ds is not limited to that shape, but any other shapes, such as square or circular ones, may be employed. In the preceding embodiments, it may be possible to provide two displays ds, and to use one display as a first display for indicating power ON/OFF status, and to use the other display as a second display for indicating access status by an electronic device.

### C8. Modified Example 8

In the preceding embodiments, when the external storage device 1, 1a is powered ON, the LED controller 72 causes the first to third LEDs 12a to 12c to emit light; and when an electronic device accesses the HDD 11 of the external storage device 1, 1a, the LED controller 72 causes the first to third LEDs 12a to 12c to flash at a time interval. However, this way of controlling the LEDs is not mandatory. The operating states of the first to third LEDs 12a to 12c may be controlled appropriately according to the operating state of the external storage device 1, 1a.

For example, while the external storage device 1, 1a is being powered ON, the LED controller 72 may maintain the first to third LEDs 12a to 12c in the light emitting state, and each time the electronic device accesses the HDD 11, the light emission of the first to third LEDs 12a˜12c is interrupted (i.e. indicating the access by flashing the display ds).

In another example, a number of different operating states may be indicated by causing the first to third LEDs 12a to 12c to emit lights with different intensities. In such a case, the first to third LEDs 12a to 12c may be switched among these operating conditions according to the operating state of the external storage device 1, 1a. To be concrete, a first and a second operating states may be established wherein the first to third LEDs 12a to 12c emit light of different intensities. Accordingly, the LED controller 72 may set up the first operating state when the external storage device 1, 1a is powered ON, and switch the operating state from the first state to the second state when the electronic device accesses the HDD 11.

With these variations as described above, too, the user of the external storage device 1, 1a can be informed of the operating state of the external storage device 1, 1a (e.g. the power ON/OFF of the external storage device 1, 1a or the access to the HDD 11 of the external storage device 1, 1a by an electronic device) by the display ds having an excellent display quality.

While the present invention has been described with reference to exemplary embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including fewer elements or only a single element, are also within the spirit and scope of the invention.

What is claimed is:

1. A lighting unit comprising:
a casing;
a light source disposed inside the casing;
a light-diffusing member for diffusing at least part of light emitted by the light source;
a light-blocking member for blocking part of the light emitted by the light source; and
a light-transmitting portion for transmitting toward the outside of the casing at least part of the light which has been diffused by the light-diffusing member,
wherein the light-blocking member is laid out straightly over the light source, the direction from the light source straightly upward being the direction of highest intensity of the light emitted by the light source.

2. The lighting unit according to claim 1, wherein
the light-diffusing member is positioned between the light source and the light-blocking member.

3. The lighting unit according to claim 1, wherein
the light-diffusing member has a first face and a second face, both intersecting the direction from the light source straightly upward, and
at least one of the first and second faces has a rugged or rough surface to alter a direction of light propagation.

4. The lighting unit according to claim 1, wherein
the light-blocking member has a function of reflecting the light emitted by the light source back into the inside of the casing, and
the light-diffusing member diffuses at least part of the reflected light.

5. The lighting unit according to claim 4, wherein
the light-blocking member has a first face and a second face, both intersecting the direction from the light source straightly upward;
wherein the first face fronts the light source and the second face is opposite to the first face;
wherein the first face has a function of reflecting the light emitted by the light source, and the second face has a function of absorbing the light passing through the first face.

6. The lighting unit according to claim 1, wherein
the light-transmitting portion is separated from the light-diffusing member, and is colored in a color similar to an emission color of the light source.

7. The lighting unit according to claim 1, wherein
the light-transmitting portion is separated from the light-diffusing member, and has a function of diffusing the light that has passed through the light-diffusing member and has entered the light-transmitting portion.

8. The lighting unit according to claim 6, wherein
the light-transmitting portion has a first face and a second face, both intersecting the direction from the light source straightly upward, and
at least one of the first and second faces has a rugged or rough surface to alter the direction of light propagation.

9. The lighting unit according to claim 1, wherein
the light source is positioned at a location that is not directly visible from the outside of the lighting unit through the light-transmitting portion.

10. An external storage device adapted for connection to an electronic device, comprising:
a storage portion for storing data;
the lighting unit according to claim 1; and
a controller for controlling operating state of the light source of the lighting unit according to operating state of the external storage device.

11. The external storage device according to claim 10, wherein
the operating state of the light source includes at least a first operating state and a second operating state different from the first operating state, and wherein
when the electronic device connected to the external storage device accesses the storage portion, the controller switches the light source from its first operating state to its second operating state.

12. The external storage device according to claim 10, wherein
at least when the external storage device is powered ON, the controller causes the light source to emit light.

13. A lighting method of conducting to the outside of a casing light emitted by a light source disposed inside the casing, the method comprising the steps of:
(a) diffusing the light emitted by the light source;
(b) blocking at least that part of the light emitted by the light source which travels in the direction from the light source straightly upward, the direction from the light source straightly upward being the direction of highest intensity of the light emitted by the light source; and
(c) conducting at least part of the diffused light to outside the casing.
